(19) United States
(12) Patent Application Publication
(10) Pub. No.: US 2005/0198085 A1
(43) Pub. Date: Sep. 8, 2005

(54) Tool for synchronization of business information

(75) Inventors: Robert V. Blakey, Burlingame, CA (US); William A. Schaffner, Seattle, WA (US); Karl Kreis, Snohomish, WA (US); Eric K. Niheu, Nework, CA (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/961,410

(22) Filed: Oct. 12, 2004

Related U.S. Application Data
(60) Provisional application No. 60/509,903, filed on Oct. 10, 2003.

(51) Int. Cl. G06F 17/30

(52) U.S. Cl. 707/204

(57) ABSTRACT

Disclosed herein are systems, electronic tools and related methods for integrating the business rules, processes, and technology necessary to enable collaboration between personal office management applications, which are used by individuals on a daily basis to organize personal contacts, appointment calendars, and tasks, with sales force management applications, which are used to manage client and account contact information and coordinate the pursuit of business opportunities across an organization. Users of both applications can have their data electronically synchronized to share specifically designated information automatically within the applications. The information designated for synchronization can be of three types having different rules regarding their sharing among the applications, wherein the types include business contacts, sales force activities, and opportunity tasks. Users can thereby manage a large synchronized base of business contacts via both their personal office management application and a sales force management application, synchronize sales force activities from their personal office management application into the sales force management application, and assign client or account opportunity action items to other users in the organization via the sales force management application, and then have those action items automatically appear to the assigned user in that assigned user's personal office management application as a task.

### FIELD OF THE INVENTION

The present invention generally relates to systems, mechanisms and related methods for effecting the synchronization of business information. More particularly, the present invention relates to systems, electronic tools and related methods for facilitating the workflow management functions of field personnel by enabling the synchronization of personal contact, calendar and task information with corporate sales planning, execution management, progress measurement and other account activity information.

### BACKGROUND OF THE INVENTION

Workers in various industries use electronic data management applications and computerized software to manage information relating to day-to-day activities and relating to organization wide projects. Commonly, however, such workers must utilize one application, such as an office management application, to handle personal contact lists, task lists, and appointment calendars, and another separate application, such as a sales force management application, to handle organization-wide project information and account activity coordination. In particular, many employees, such as field personnel and sales force personnel in particular, may find it difficult to use a personal office management application to enhance their personal day-to-day productivity while also using a second tool, such as a sales force management application, across the organization for the storage and distribution and tracking of corporate activities, such as sales or project planning, execution, measurement and record keeping.

Computer literate employees in many industries are often very familiar with at least one personal office management application because those employees make frequent use of that application for tools relating to email handling, as well as for managing personal task lists, personal contacts lists, appointment calendars. Typically, a personal contact in the context of personal office management applications is equivalent to an electronic rolodex entry that designates particular information relating to person or organization, such as telephone and facsimile numbers, business (correspondence, shipping, etc.) addresses, email addresses and other relevant rolodex type information. Contact entries can grouped, sorted, and searched, and ultimately employed to by the user to facilitate the creation and sending of communications (emails, letters, facsimiles, etc.). Tasks, sometimes called to-do items, commonly are descriptions of a particular job to be done associated with a time frame for doing that job, and often tasks may optionally support a progress indicator regarding the status of the task (completed, not started, percentage completed, etc.). Personal office management applications typically allow the user to organize tasks in lists (like the electronic version of a reminder list) and have the lists generate reminder prompts for upcoming task deadlines. Furthermore, personal office management applications also typically contain a calendar function that lets users keep track of upcoming appointments with contacts or other persons, and have the application generate reminders regarding upcoming appointments. Given the frequency with which users may use personal office management applications for email purposes, it is often the case that they develop familiarity with and comfort regarding the use of the contacts, tasks and calendar features.

Field sales organizations also commonly utilize, in addition to personal office management applications, electronic tools specifically adapted to help their organization sell collaboratively across geographies, time zones, and currencies, and adapted to scale as the number and depth of accounts and clients grow more complex. Field sales representatives in particular desire access to the information that enables them to accurately forecast future business, generate customized presentations and proposals, and easily knowledgeable produce customer communications to the appropriate contact persons at the customer organization. Commercially available sales force management applications are therefore often used by field sales organizations because they allow those organizations to share information organization-wide across sales teams, manage proposals and sales pipelines, and generally provide improved service and support.

Commercially available sales force management applications support account management and activity tracking that enables field sales representatives to build a deep understanding of target accounts with a complete history of all the interactions that members of their sales organization has had in that account. Typically, sales representatives use sales force management applications to track and record a history of account/client related activities such as “touch points” and meetings with that account/client, and to plan and establish to-do lists of action items for coordinating the pursuit of new business opportunities with existing accounts/clients. These touch points are recorded in a central database by the sales force management application to provide an organization-wide detailed record regarding dealings with particular current or prospective clients and accounts. Also, such sales force management applications typically permit action items associated with account opportunities to be assigned to particular sales force members, and then track completion of those assigned required action items by receiving electronic status updates from the assigned sales force members.

The functionality of sales force management applications supporting the tracking of past touch points, activities or meetings between sales staff and accounts/clients to some extent serves as a record of past appointments with clients, and field sales representatives will often still use personal office management applications to schedule calendar appointment reminders for meetings with clients. Even though such personal calendar appointments are only intended to serve merely as a personal reminder for a given user while meetings and activities retained by a sales force management application are meant to track the business relationship and contact points between the business contact and the sales force on an organization-wide basis, employees may resist, either through laziness or lack of appreciation of differences of both applications, having to repeat the process of entering information into the sales force management application regarding completed meetings because they've already previously created a personal calendar item regarding those meetings.

Similarly, field sales representatives using both personal office management applications and sales force management applications may find it difficult to distinguish between and properly use task lists offered by their personal office management application and resolve action items assigned to them in the sales force management application. Thus, users of both applications may become confused regarding or disenchanted with the need to simultaneously manage a list of tasks and action items using two different applications.

Further, sales force management applications serve as a centralized repository of organization-wide information regarding all current and prospective client accounts, including contract and/or sales account contact information. This contact-type information is kept for each account and, while similar to personal contacts in some respects, will typically contain types and fields of information that are not normally tracked (or capable of being tracked) using the personal contacts features of a personal office management application. A sales account contact record could contain, for example, information relating to account identifications, invoicing instructions and other like account-related information necessitated by the sales force management application. However, significant information between the two types of contacts will overlap, often resulting in redundant data being separately managed by both types of applications and thus requiring the upkeep of two independent database records by field sales representatives.

This and other areas of perceived redundancies and partial overlap between the uses of sales force management applications and personal office management applications can cause employees to improperly use or under use one or both applications. Synchronization of appropriate data between these two common types of office management applications would be desirable, as it would facilitate the coordination of employee functions that are organization-wide basis by leveraging the strongest features of each tool and allowing each end user to access and modify data through the preferred interface. In particular, there is a need in the art for efficient technologies and methods that easily enable collaboration between commercially available personal office management applications used by many individual employees on a daily basis to organize personal contacts, appointment calendars, tasks, and e-mail with sales force management applications used to manage client and account contact information and coordinate the pursuit of business opportunities on a organization-wide basis.

Thus, there remains a need in the art for systems, electronic tools, and related methods for synchronizing the common types of information handled in related personal office management functionalities and sales force management functionalities.

### SUMMARY OF THE INVENTION

In light of the above described and other deficiencies inherent in the art, it is an object of the present invention to provide systems and electronic tools that have workflow and information management features suitable for assisting users whose majority of work is performed outside the office in direct contact with customers.

Furthermore, it is an object of the present invention to provide tools and related methods for synchronizing data between a central project management information system and multiple remote contact and task information systems.

Additionally, it is also an object of the present invention to provide a system and related methods for synchronizing records regarding upcoming account opportunities and action items set up in a sales force management application with a particular assigned user's task lists or “to-do” items in that user's personal office management application.

Also, it is an object of the present invention to provide electronic tools and related methods that promote improved data retention by users relating to contacts with current or potential clients and accounts.

The present invention addresses the need in the art for efficient technologies and methods for integrating the business rules, processes, and technology necessary to enable collaboration between personal office management applications used by many individual employees on a daily basis to organize personal contacts, appointment calendars, and tasks with sales force management applications used to manage client and account contact information and coordinate the pursuit of business opportunities on a organization-wide basis.

Individualized users of both a personal office management application and a sales force management application according to embodiments of the present invention can have these applications electronically synchronized to share specifically designated information electronically between both types of applications. In the embodiments of the present invention as described herein, the information designated for synchronization can be of three types having different rules regarding their sharing among the applications, wherein the types include business contacts, sales force activities (e.g., appointments with clients or accounts), and opportunity tasks. Embodiments of the present invention allow individual users to manage a large synchronized base of business contacts via both a personal office management application and a sales force management application. The business contacts may be created via the interface of either application and then made accessible and modifiable via the other application's interface, and they are adapted to support the different types and fields of information required by both applications respective type of contacts. Such synchronizable business contacts may be first created or later accessed and edited via the personal office management application using free form fields, pick lists, multiple variable group lists or other data entry methods to limit bounded data fields dictated by the sales force coordination tool. Additionally, a sales account contact record maintained in the sales force coordination application, containing organization-wide sales contact information, can be populated down into employees' personal office management application from their organization's sales force management application base to create the synchronizable business contacts, and changes to sales account contacts already synchronized as business contacts would be reflected in the personal office management application. Thus, users may create or modify contacts from either application as well as view organization-wide contact information through the same interface that they would normally review their personal contacts information. Since these business contacts are synchronized between the two applications, changes to the contacts in either application would be ultimately reflected in both applications.

Embodiments of the present invention also enable users to synchronize sales force activities from the personal office management application into the sales force management application. Sales force activities are created from past appointments scheduled in a user's personal calendar that have occurred. Those occurred calendar appointments that were associated with one or more business contacts are synchronized as appropriate to create sales force activities for those one or more associated business contacts. These sales force activities are synchronized into an organization-wide database managed by the sales force management application that tracks meetings, “touch points” by organization's employees, and its sales force employees in particular, with business contacts and clients (such as in person meetings, telephone calls, formal business letters and proposals, etc.). In this manner, meetings scheduled as an appointment by an employee using their local personal office management application, where those meetings involve a business contact, can be synchronized and recorded automatically by the organization-wide sales management application after that meeting with that business contact or client has actually occurred. In this manner, a user may be freed from the need to make a manual entry into the sales force management application to record a touch point when that touch point was previously scheduled in their personal calendar as an appointment with a business contact.

Additionally, embodiments of the present invention enable users to assign client or account opportunity action items to other users in the organization via the sales force management application, and then have those action items automatically appear to the assigned user in that assigned user's personal office management application as a task. The assigned user can then review, accept or reject, and record progress updates for such items/tasks assigned in this manner, referred to herein as opportunity tasks, from the interface of either their personal office management application or the sales force management application. This aspect of the present invention allows users to drive their day-to-day opportunity action item management from interface of the particular tool of choice. In many cases, this is the personal office management application because employees have more frequent use of that tool for managing personal task lists, as well as personal contacts lists, appointments and email. In this manner, employees who are more familiar with their office management application would not be required to utilize the interface of the sales management application frequently on an everyday basis because opportunity tasks may be managed from the personal office management application.

Embodiments of the present invention employ both automatic synchronization and manually triggered synchronization of relevant information between each application. Automatic synchronization according to the present invention generally occurs at the start up and/or shut down of each application. Manual synchronization (initiated by the user) enables immediate synchronization while one or both applications are running. Preferred embodiments of the present invention also support synchronization of information from PDAs or other like portable computing devices that may not normally serve as a standard platform for sales management applications but which nonetheless support task management, appointment calendars, or contact features.

Understandably, personal contacts are often not completely equivalent in use and in types of information handled when compared to sales account contacts, and personal tasks items are similarly often not completely equivalent to client or account opportunity action items as handled by and combination of personal office management application and sales force management application. Thus, in certain embodiments of the present invention, custom forms are developed and provided for use as plug-ins within one or more of the two applications to ensure that data integrity is maintained between the various applications. In this manner, sales force management application information, which could include specific domain values not supported by the personal office management application, can be handled, viewed and managed within the personal office management application, even if that personal office management application does not normally provide handling of those specific domain values. For example, a custom form can provide the ability to create new fields not present in a personal office management application's standard personal contact entry form where the custom form allows the capture of critical data used for reporting, billing, or some other back end process managed on an organization-wide basis by the sales account contacts. Thus, a “business contact” could be supported in the personal office management application that corresponds in domain values to the sales account contacts in a sales force management application. Optionally, these business contacts could be supported separate and apart from the standard “personal” contacts offered by an un-synchronized personal office management application. This would offer users the ability to keep and manage synchronized business contacts separate and apart from personal contacts.

In preferred embodiments of the present invention, a synchronized business information management system is provided, comprising a personal office management component in electronic communication with a sales force management component via a queue component. The office management component comprises an office management application, preferably a commercially available application such as Microsoft Outlook for Windows XP, and the sales management component comprises an organization-wide sales management application such as a Siebel Sales Management application, preferably Siebel Sales Enterprise. In such preferred embodiments, a synchronization engine is provided which serves as the middleware of the system and comprises the queue component that passes data back and forth between the two applications for synchronization. In such preferred embodiments, the middleware utilizes a queue application, such as Microsoft Queue, which is configured to transmit data between databases associated with the other components in the form of XML data through XSLT conversions.

In one preferred embodiment of the present invention, the office management application comprises Microsoft Outlook XP and the sales force management application comprises Siebel Sales Enterprise 7.0.

The queue component in embodiments of the present invention enables end-users to synchronize designated business contact, sales force activity and opportunity task information between the respective databases of a personal office management application and a sales force management application. This functionality facilitates the workflow of field personnel seeking to use applications to enhance personal productivity and for the storage and management of corporate activities such as sales planning, execution and measurement. This synchronization supports improved workflow because certain employees, such as sales force field personnel, may find it difficult to use a personal office management application to enhance their personal productivity while also using a sales force management application across the organization for the storage and distribution and tracking of corporate activities, such as sales planning, execution, measurement and record keeping. In this manner, the present invention is particularly suitable for sales force related employees, such as account managers and partner managers, where the realities of the business dictate that the majority of work is done by a remote or mobile sales force in direct contact with customers.

The various embodiments of the invention having been thus described, preferred embodiments thereof will now be described in detail with reference to several figures.

### Brief Description of the Drawings

FIG. 1 is schematic diagram depicting a synchronized business information management system according to embodiments of the present invention.

FIG. 2 is a flow chart depicting a manual synchronization process as may be initiated by a user via the personal office management component according to one embodiment of the present invention.

FIG. 3 is a flow chart depicting a manual synchronization process as may be initiated by a user via the sales force management component according to one embodiment of the present invention.

FIG. 4 is a screen view depicting one preferred embodiment of a custom form for accepting and displaying business contact information from the interface of a synchronized personal office management application according to preferred embodiments of the present invention.

FIG. 5 is a screen view depicting an alternative view of the custom form of FIG. 4, demonstrating the use of a tabbed form layout to sort different types of synchronized business contact information when accessing business contacts from the interface of a personal office management application.

FIG. 6 is a screen view depicting an alternative view of the custom form of FIG. 4 and FIG. 5, demonstrating the use of a tabbed form layout to sort synchronized business contact information from unsynchronized information associated in the personal office management application with that business contact.

FIG. 7 is a screen view depicting one preferred embodiment of a custom form for accepting and displaying opportunity task information from the interface of a synchronized personal office management application according to preferred embodiments of the present invention.

FIG. 8 is a schematic diagram depicting the association of various personal office management components, corresponding to various users, with a centralized organization-wide sales force management component according to one embodiment of the present invention.

### Detailed Description of the Preferred Embodiments

The present invention enables end-users to synchronize business contact, sales force activity, and opportunity task information between the database of an employee's personal office management application and the database of a sales force management application. Synchronization of appropriate data between these two common types of applications commonly used in the sales force environment facilitates the coordination of employee functions on an organization-wide basis by allowing each end user to access and modify data through the interface of their preferred application, and thus promoting use of both of the tools.

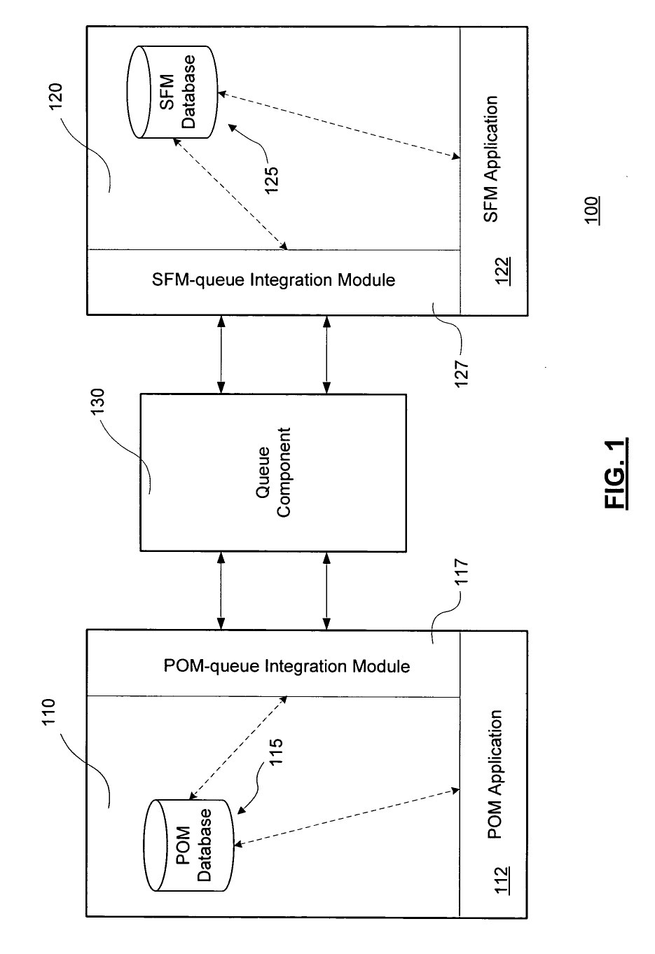

FIG. 1 is a schematic diagram depicting the architecture of a synchronized business information management system 100 according to embodiments of the present invention that produces synchronized personal office management functionality and sales force management functionality. As depicted in FIG. 1, the system 100 includes a personal office management (“POM”) component 110 in electronic communication with a sales force management (“SFM”) component 120 via a queue component 130. As depicted in the figure, the POM component 110 includes a personal office management application (“POM application”) 112 which provides a front end user interface to various electronic tools for managing personal contact, appointment and task data stored in the POM component's personal office management database (“POM database”) 115. As will be readily appreciated by one of ordinary skill in the art, the POM application 112 will typically comprise a commercially available office management application such as Microsoft Outlook or Lotus Notes running on the local, and often portable, computer of a given sales force employee. The POM database 115 comprises a modified version of the standard database that would accompany the appropriate office management application and typically be adapted to store and manage the personal contact, appointment, and task information generated by the application. In embodiments of the invention, the POM database 115 has been appropriately modified to contain the synchronized data, including business contact information, opportunity task information, sales force activity information in addition to the employee's personal office management data used by the standard features of the POM application. Additionally, POM component 110 comprises a POM-queue integration module 117 that operates in conjunction with the POM application 112. The POM-queue integration module 117 provides the support coding and functionality necessary to modify the POM application 112 and enable synchronization functionality including writing data to and reading synchronized data from the queue component 130. Preferably, the POM-queue integration module 117 provides processes for XML data exporting and importing of synchronized records (generally referred to herein as writing to and reading from the queue, respectively), manually and automatically initiated synchronization processes, and XSLT conversion of XML exported and/or imported data flowing to and/or from the queue component 130.

The SFM component 120 also comprises a database, in this case the sales force management database (“SFM database”) 125. The SFM component 120 likewise includes a sales force management application (“SFM application”) 122 which provides a front end user interface to various electronic tools for managing sales account contact, meetings and touch points with accounts or clients, and client or account opportunity action items. As will be readily appreciated by one of ordinary skill in the art, the SFM application 122 will typically comprise a commercially available sales force management or coordination application such as Siebel Sales running on the local, and often portable, computer of a given sales force employee. Since the SFM component 120 would typically comprise a commercially available management and coordination application, the SFM database 125 would contain organization wide sales planning, execution management, and progress measurement information for particular clients and projects associated with a group of employees (such as a sales force). Like the POM database 115, the SFM database 125 would contain slight modifications as necessary to enable efficient synchronization of data with the POM component 110.

The queue component 130 as depicted in FIG. 1 is situated between the personal office management component 110 of each employee and the sales force management component 120 to provide a means for synchronizing appropriate information between the two databases 115 and 125. The queue component 130 is used as a temporary data storage area between components 110 and 120 for data that needs to be synchronized. Both components 110 and 120 write to and read from the queue as depicted in the FIG. 1.

As with the POM component 110, the SFM component 120 similarly contains a SFM-queue integration module 127 that operates in conjunction with the SFM application 122. The SFM queue integration module 127 provides the support coding and functionality necessary to modify the SFM application 112 and enable synchronization functionality including writing data to a reading synchronized data from the queue component 130. The SFM-queue integration module 127 also preferably provides processes for XML data exporting and importing of synchronized records, manually and automatically initiated synchronization processes, and XSLT conversion of XML exported and/or imported data flowing to and/or from the queue component 130.

In preferred embodiments of the present invention, the personal office management application comprises Microsoft Outlook and the sales force management application comprises a Siebel Sales management application. Preferably, the personal office management application comprises the application Microsoft Outlook XP, and the sales force management application comprises Siebel Sales Enterprise 7.0. These two main application components allow data to flow between Outlook and Siebel via the queue component, which preferably is a queuing program capable of handling queue functions for XML data transmission, such as Microsoft Queue. Synching occurs whenever a given application, either the personal office management application or the sales force management application, is open or closed automatically as described below. Also, in such preferred embodiments, synching may also be initiated manually in either application when both are running simultaneously. In automatic synching, whenever an application is launched, data (previously written to the queue by the other application) is read from the queue component. Similarly, when an application is closed, data is written to the queue (to be read subsequently by the other application). Additionally, data in certain optional variations of the present invention may be written manually or on a transactional basis to the queue as described below.

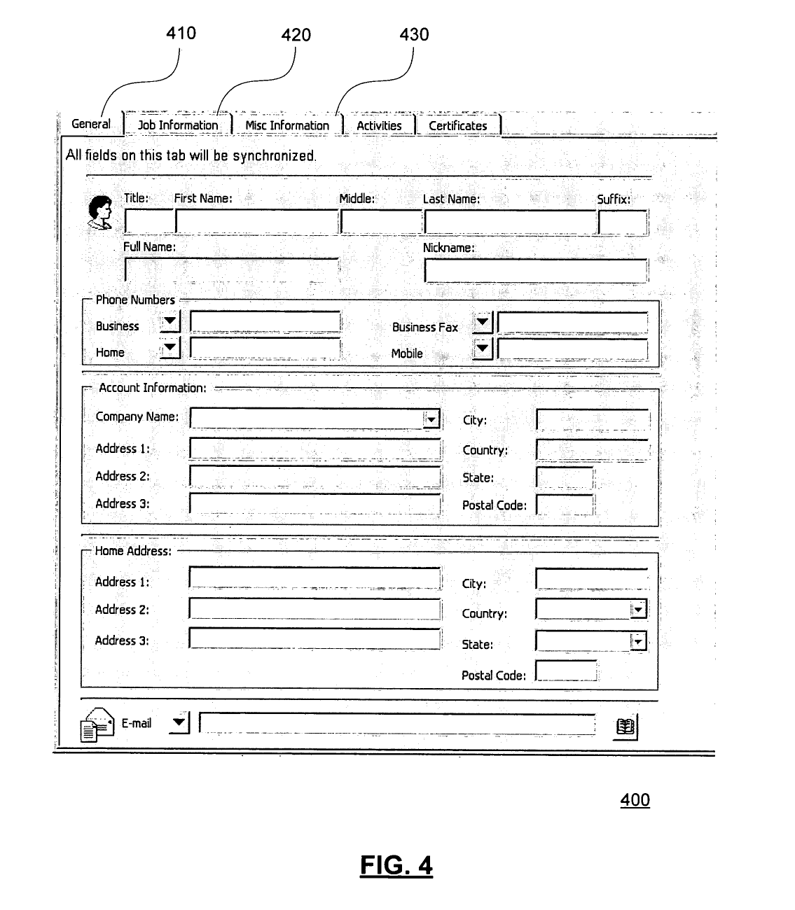

In the preferred embodiments of the present invention wherein the personal office management component 110 utilizes Microsoft Outlook, the POM-queue integration module 117 comprises custom code integrated into Outlook as an add-in. The add-in serves the function of reading from and writing to the queue, creating user menu items, creating fields in Outlooks database for new data fields, and monitoring events. Module 117 also includes custom forms created for “business contacts” and “business opportunities/tasks.” Such custom forms are published to Outlook during installation of the application such that they are available for use via the Outlook interface by users. The use of such custom forms via the Outlook interface according to such prepared embodiments of the present inventions will be discussed below with respect to FIGS. 4-6.

Also, in such preferred embodiments of the present invention wherein the sales force management application 122 comprises Siebel Sales Enterprise, the Siebel application is modified via the SFM-queue integration module 127 using Siebel VB to call an external synchronization process that uses XML/XSLT to automatically synchronize the databases for the two applications. This synchronization functionality allows the Siebel database, corresponding to the SFM database 125 of FIG. 1, to read from and write to the queue of the queue component. Additionally, changes to the Siebel database would be implemented with the SFM-queue integration module 127 such that the database 125 supports required additional fields, such as synchronization flags for business contacts and dates of last synchronization, as will be understood after reading the description of the synchronization processes as set forth below. As will be readily appreciated by one of ordinary skill in the art, the configuration of elements comprising the SFM component in this preferred embodiment is intended to minimize impact upon the core Siebel application functionality.

In embodiments of the present invention, synchronization between the personal office management component and the sales force management component can be driven by the respective tools or applications of either component. At initialization, each component's application, due to the processes added into them via their respective queue integration modules, will read updates from the queue. Conversely at shut down both components' applications will write records that have been updated to the queue. Synchronization for either component can occur either automatically, manually, on a transactional basis, or some combination thereof.

Synchronization can be driven from within the personal office management application in three manners: automatic synchronization, manual synchronization and utility synchronization. In automatic synchronization, during the start up of the POM application, the automatic synchronization process provided by the POM-queue integration module checks the message queue for any updated messages from the SFM application. If updates are found, the tool will process those records and update the POM database accordingly. Additionally, during each initialization, the POM application will read the queue to identify and process any updated bounded domain values from the sales force management application. These bounded domain values are used to define the various pick-lists or multiple value group lists utilized in one or more of the input forms provided for the user interface of the personal office management application (as will be described in detail below). During shut down of the POM application, the application scans through various opportunity tasks records to identify those opportunity task records that have been updated via the POM application since the last synchronization (utilizing a “last synchronized” database field in the POM database created to support the present invention). Similarly, the application scans through the business contacts records to identify those records that have been updated via the POM application since the last synchronization. Any opportunity task and business contact records that fulfill these criteria will then be written to the queue. Likewise, the POM application will also scan for meetings and appointments with business contact records that have been designated to synchronize with the sales force management application. Any such meetings or appointments that have this synchronization designation and that have occurred in the time frame since the last synchronization will be written to the queue.

In optional alternative embodiments of the present invention, it is possible for records changed in the POM application interface to be written to the queue on a transactional basis in automatic synchronization. For example, once a business contact is edited and closed (thus “saving” the edits) in the POM application, the application will not only save that altered record in the POM database but will also perform an immediate write to the queue for that record. Thus, the automatic synchronization process at shutdown of the POM application wouldn't necessarily need to scan for changes to business contacts, as those changes would have already been written to the queue on a transactional level.

In preferred embodiments of the invention, a PDA synchronization ability is provided. During shutdown of the personal office management application, the user in these embodiments will be presented with an option to include a full PDA scan to determine if any business contacts, opportunity tasks, or calendar appointments with business contacts have been updated. This can be done, for example, by having the POM application tool scan through a local POM database on the PDA to locate relevant records that have been updated (having a last modified date more recent than the date of last synchronization of the POM application). Records that fulfill this criteria are then written to the queue along with records from the local POM database. As will be readily appreciated by one of ordinary skill in the art, this ability, of course, can be extended to support other remote data access features for the particular POM application used, such as, for example, Web access for Microsoft Outlook.

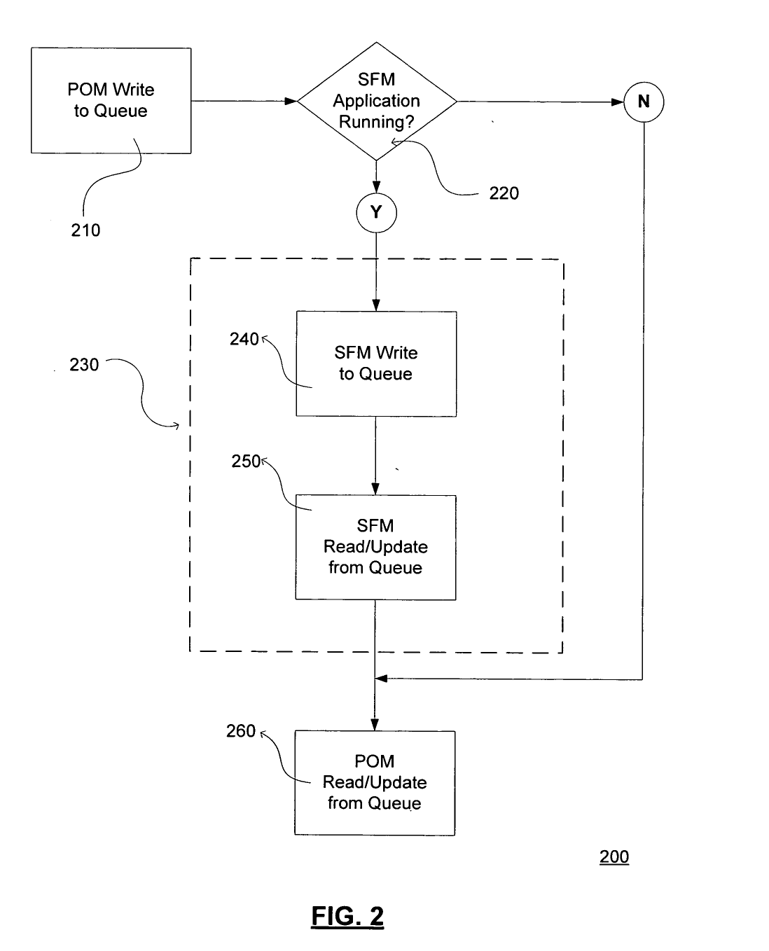

Manual synchronization is also available from the POM application in embodiments and present invention. FIG. 2 is a flow chart depicting a manual synchronization process 200 as may be initiated by a user via the personal office management component according to one embodiment of the present invention. Manual synchronization can be made available through the POM application's main user interface and selectable by a user in manners that are known in the art, including through the providing of a toolbar button or through a menu item. The first step of manual synchronization process 200 is to perform an immediate write to the queue from the POM database at step 210. This write to the queue would include essentially the same write to the queue employed in the automatic synchronization described above. Namely, the process 200 scans through various opportunity tasks records and business contact records in the POM database to identify those records that have been updated since the last synchronization. Any updated records are written to the queue. Also, process 200 scans for meetings and appointments with business contact records that have been designated to synchronize with the sales force management application and that have occurred in the time frame since the last synchronization. These records are also transferred to the queue to be held for transmission to the SFM database upon demand.

Next, a determination is made at 220 regarding whether the SFM application is running concurrently (i.e., is “open”) with the POM application. If the SFM application is determined to be running at 220 when a manual synchronization process 200 is initiated via the POM application, the process 200 performs a full synchronization with the SFM component and updates the SFM database in real time (sub-process 230 ). If the SFM application is determined at step 220 to be not open, the process 200 proceeds to step 260 after writing all updated records to the queue at step 210. In these instances where the SFM application is not concurrently running, any changes written to the queue from the POM database in would then, of course, be populated into the SFM database the next time the SFM application is initialized (in its associated automatic synchronization process).

Sub-process 230 as depicted in FIG. 2 can be broken down into steps 240 and 250. When the SFM application is open during manual synchronization process 200, it will first perform a write to the queue at step 240. This write to the queue causes the process 200 to scan the business contact and opportunity task records in the SFM database to identify records designated for synchronization that have been updated via the SFM application interface since the last synchronization (automatic or manual). Records fitting these criteria are transferred to the queue to await subsequent transfer to the POM database. Further, step 240 will also check for updated (since the last synchronization) bounded domain values from the SFM application which are used in various pick-lists in the POM custom forms as described below. Updated bounded domain values are also written to the queue at step 240.

Step 250 of sub-process 230 comprises the reading the queue for any updated records that need to be transferred to the SFM database. This would include any records written immediately above at step 210 as well as any other records that had not yet been written to the SFM database.

Finally, at step 260, the POM application will check the queue for any updated record messages from the SFM application. If any updates are found, the POM application will process the records accordingly and update its database. The manual synchronization process 200 is thus completed.

In preferred embodiments of the present invention, a utility synchronization feature is available to “refresh” business contact and opportunity task information in the POM database. This utility synchronization feature takes all the data linked in the SFM database for synchronization back over to the POM database in the form of a complete overwrite of business contact records in the POM database with their corresponding records in the SFM database. This feature is provided to prevent “orphaned” business contacts and opportunity task information and thereby allow both applications and their databases to stay in constant sync in the event of backend updates or other circumstances which cause changes to be synchronized records in either one of the two databases without triggering a synchronization event.

From the perspective of the SFM application, automatic synchronization and manual synchronization are performed in substantially the same manner as described above with respect to the POM application. For automatic synchronization, during startup of the SFM application, the application will first check the message queue for any updated messages written to the queue by the POM application. If any updates are found, the SFM application will process those records and update its SFM database accordingly. During shutdown of the SFM application, the automatic synchronization process will scan the business contacts and opportunity task records to identify any records that have been updated via the SFM application interface since the last synchronization. Records that fit this criteria are written to the queue. Similarly, during the shutdown of the SFM application, the automatic synchronization process will also write any updated bounded domain values to the queue.

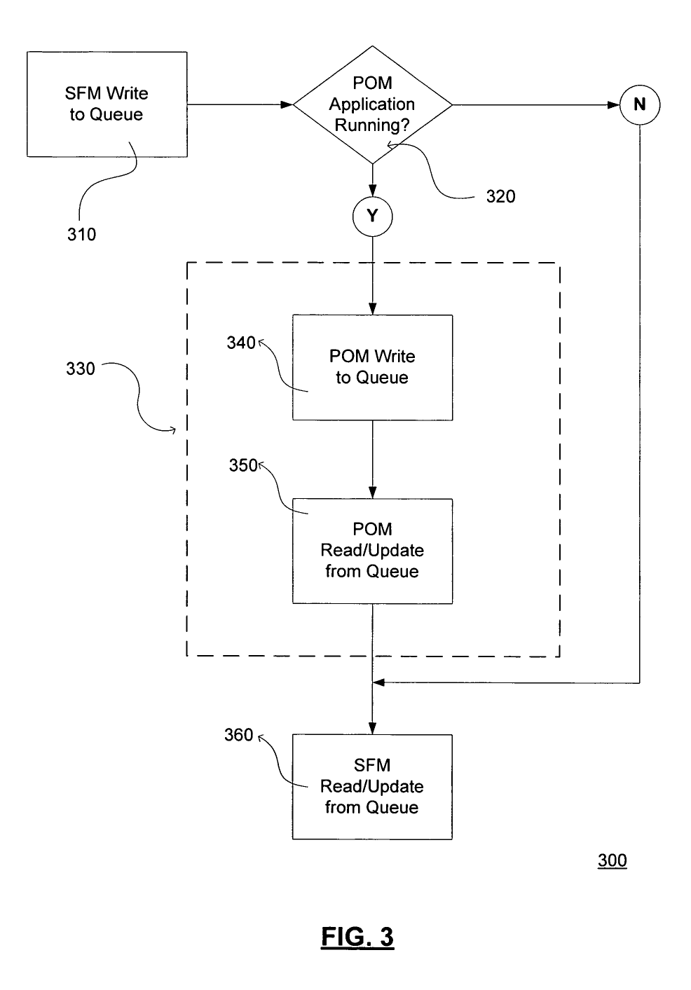

A manual synchronization process 300 as depicted in FIG. 3, similar to process 200 of FIG. 2, may be similarly initiated via the SFM application interface. The first step of manual synchronization process 300 is to perform an immediate write to the queue from the SFM database at step 310. This write to the queue would include essentially the same write to the queue described with respect to step 240 of process 200 above. Any records written to the queue at step 310 are held there for transmission to the POM database upon demand.

Next, a determination is made at 320 regarding whether the POM application is running concurrently with the SFM application. If the POM application is determined to be running at 320, the process 300 performs a full synchronization with the POM component and updates the POM database in real time through sub-process 330. If the POM application is determined at step 220 to be not open, the process 300 proceeds to step 360, described below. Again, in instances where the POM application is not open, any changes written to the queue from the SFM database in would later be populated into the POM database the next time the POM application is initialized.

Sub-process 330 as depicted in FIG. 3 mirrors that of sub-process 230 of FIG. 2. When the POM application is open during manual synchronization process 300, sub-process 330 will first perform a write to the queue from the POM database at step 340. This write to the queue at step 340 is similar to the write to the queue as described above with respect to step 210 of process 200. At step 350, queue is read, and any records therein from the SFM database are written to the POM database.

Finally, at step 360, the SFM application will check the queue for any updated record messages from the POM application. If any updates are found, the SFM application will process the records accordingly and update its database. The manual synchronization process 300 is thus completed.

As will be readily appreciated by one of ordinary skill in the art, it is commonplace for a sales force management application running on a client device to operate on data resident on both a local SFM database and a main SFM database located on a remote server. The SFM application can therefore be operated in an online processing mode, wherein the SFM application is directly connected to the remote server database, or in an offline processing mode wherein the SFM application is connected to and operating off of a local SFM database which mirrors the central database. In embodiments of the invention as described herein, it should be understood that any references to the SFM database apply equally to either database and that data integrity would be maintained under the normal data integrity controls employed by the standard (non-synchronized) version of the SFM application.

Discussion now will be directed to the various data and record types which can be synchronized between the SFM component and the POM component in preferred embodiments of the present invention. In embodiments of the present invention, the information synchronized between the POM component and the SFM component includes data records for business contacts, sales force activities (e.g., appointments with clients or accounts), and opportunity tasks. The table below summarizes the relevant record update data that is permitted by the queue component to flow between the POM and SFM components to enable synchronization of these three types of records according to embodiments of the present invention.

TABLE 1

| Item | POM -> SFM | SFM -> POM |
|---|---|---|
| Business Contacts | Yes | Yes |
| Opportunity tasks | Yes | Yes |
| Sales Force Activities | Yes | No |

The first record type shown in Table 1 is business contacts. In preferred embodiments of the invention, business contacts can be created and designated in either the POM application or the SFM application for synchronization, and they will synchronize both ways (i.e., changes to a business contact in either application will synchronize that change to the other application's database). This two-directional flow of update data is represented in Table 1 by the “Yes” entry in both columns for the “business contacts” row. Since SFM sales account contact records typically differ in purpose and intended use, and therefore differ in number and subject of associated content fields from a POM application's personal contact records, embodiments of the present invention utilize a custom business contact form within the POM application interface to allow the creation and/or modification of business contacts that are intended to be synchronized with the SFM database and application. Thus, any personal contacts generated using standard forms in the POM application interface (which may be also referred to herein as non-business contacts) will not be synchronized to the SFM application due to the mismatching of fields for those records. Business contacts will, preferably, resemble personal contacts in many ways to facilitate their operation and usage in the POM application's interface, but, through the use of custom forms as described herein, they will be adapted to contain additional fields corresponding to the fields required by the SFM application for its version of sales account contacts.

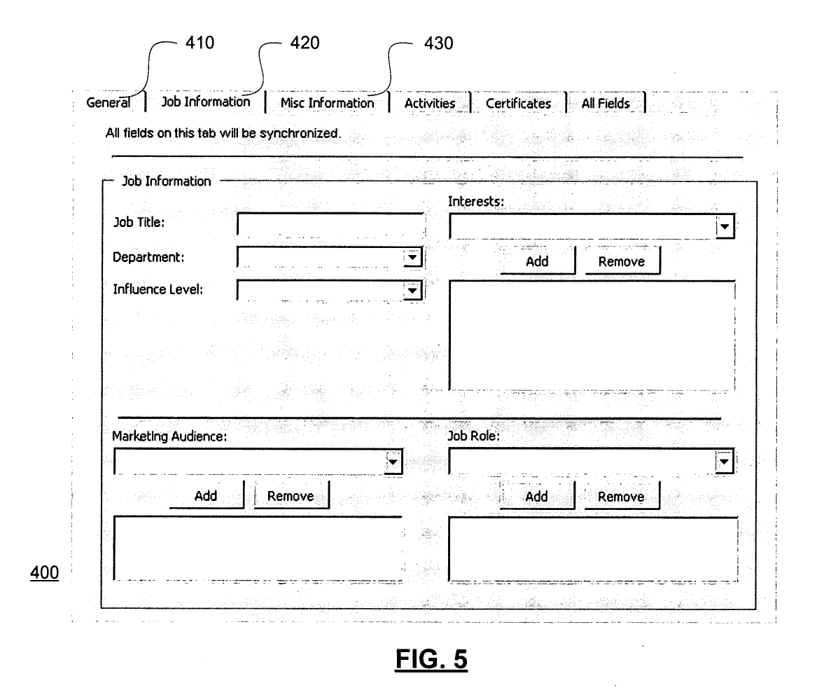

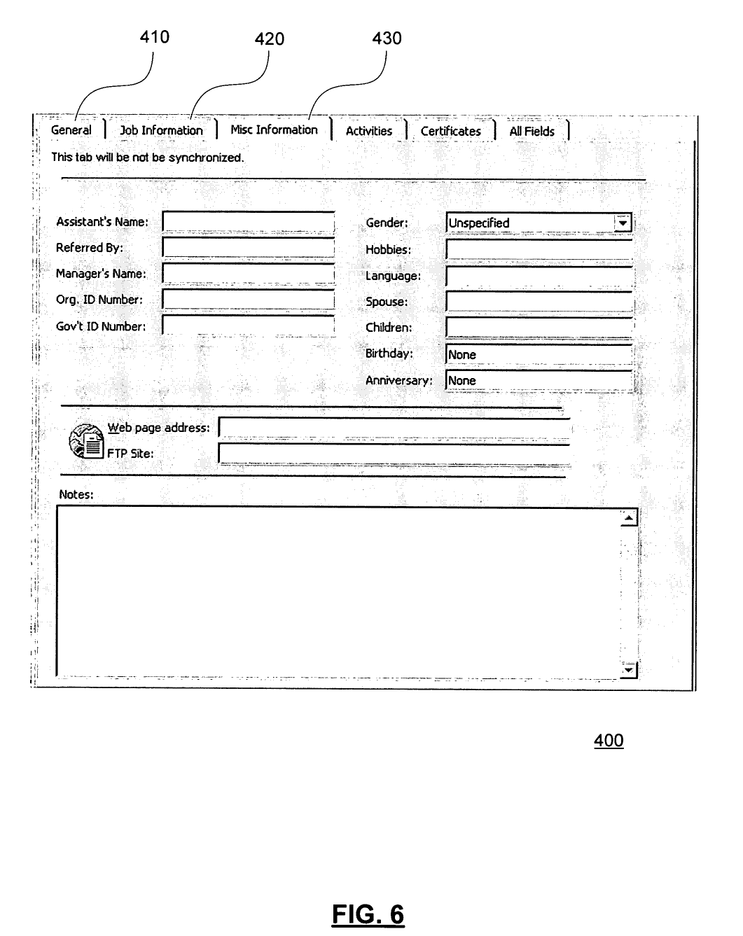

Business contacts records can be viewed, updated and/or created via the POM application interface in a manner similar to that used for non-business contacts, such as via a button on a main toolbar or through a menu item. The opening of a particular business contact or initiation of a new business contact record will cause the display of a custom business contact form. A screen view of a business contact custom form 400 is depicted in FIG. 4 as it may be used in preferred embodiments of the present invention wherein the POM application is Microsoft Outlook and the SFM application is Siebel Sales. As is known in the art, custom form 400 can utilize the known tab construct to allow the user to view different groups of input fields for the business contact as is depicted in FIGS. 4 through 6. Custom form 400 as shown in FIG. 4 has the general tab 410 selected, which tab provides the user with a display of and access to the basic identifying information regarding a particular business contact. This basic identifying information can include a name and title of a primary contact person, the company name, phone and fax numbers, correspondence addresses and email addresses as is depicted. A second “job information” tab 420, depicted as being selected for display by the user in FIG. 5, contains more information that will typically be necessary to be synchronized with the SFM database. This business contact data falling in the job information category can include a job and/or contract or account title, department assignments within the organization, marketing audiences, job roles, and interests as is depicted. Custom form 400 may have various other tabs, including a miscellaneous information tab 430 that is shown as being selected by the user in FIG. 6, that may contain information that is not intended to be synchronized with the SFM database.

These various other tabs allow for the business contact to take the place of the non-business contacts traditionally provided by the POM application by providing fields that are only retained in the POM database where those fields correspond to fields offered in the POM applications non-business contacts. In this manner, the need to maintain duplicative business contacts and non-business contacts is lessened.

As is shown in FIGS. 4, 5 and 6, the customized form 400 preferably visibly delineates which fields are going to be synchronized to the SFM application by grouping like-synchronized data appropriately within tabs indicating the synchronization orientation prominently so along the top of each tab. This assists users in identifying which fields may be required and which fields may be optional by the SFM application, as those fields that are to be synchronized may be required for a business contact. Also, as shown in FIG. 5, account and job information is preferably entered the customized form using bounded pick lists and multiple value group lists. In this manner, the entry of account information must be made from a select list of possibilities where these possibilities are defined by a list of possibilities defined by the universe of different entries present the SFM database. These lists are only expandable via the SFM application interface and are populated to the POM application during synchronization processes. Thus, an account selection can be changed for a given business contact in the POM application, but new account values can only be created via the SFM application. Therefore, integrity of account data and account naming conventions can be more easily managed as the SFM application interface is especially adapted to support this type of data management.

Also, to prevent the modification of account information present in the SFM database, business contact information synchronized from the SFM database to the POM database preferably would not be modifiable via the POM application interface if that account isn't one of that particular user's accounts (accounts often being assignable through SFM applications to one or more given users). In other words, the account information for synchronized business contacts will preferably be shown as “read only” in the POM interface to users not having account management status such that inadvertent or unintentional changes to account information in the SFM database can be avoided. Additionally, the primary address for business contacts can optionally be made to default to the primary address used for the account in the SFM database. Users would, of course, still be able to select alternate addresses for accounts having multiple sites.

Also, in further effort to maintain integrity of the SFM database, if a business contact is deleted via the POM interface, that contact will be removed from the POM database and an appropriate delete message regarding that business contact will be written to the queue upon the next synchronization. However, this delete message preferably will not cause the corresponding record in the SFM database to be deleted in preferred embodiments of the present invention. That particular contact record will remain in the SFM database and be accessible via the SFM interface, but that contact will no longer be synchronized over to the POM database in the future.

Optionally, the present invention allows business contacts to be converted into non-business contacts by initiation of a conversion process through, for example, a menu selection available in the POM application interface. If a business contact is converted into a non-business contact, the flag for that contact record in the SFM database will be changed to a no-synchronization value (indicating no synchronization should occur in the future for that particular contact) and fields from the business contact form for that record are used to populate the corresponding fields in the standard non-business contact supported by the POM application. In such cases, preferably the account information and other non-standard business contact information are retained in the non-business contact (such as in comma-delineated form and entered into a “Notes” free-form text input field associated with the personal contacts of the particular POM application). Similarly, non-business contacts can optionally be converted into business contacts via an appropriate menu selectable conversion process. If a contact is converted into a business contact in this manner, a corresponding contact record may be updated or created in the SFM database, if necessary.

In embodiments of the present invention, business contact records can also be managed through the SFM application interface. As indicated above, sales account contact information records in the SFM database according to the present invention are modified from the standard (non-synchronizable) SFM database by creating an additional field in the SFM database for each sales account contact record. This field can be referred to as a “synchronization flag” because, as indicated above, this field merely serves as an indicator regarding whether that field should be synchronized with the POM database belonging to a particular identified user. Thus, creation and modification of any contact record within the SFM application would be handled using standard procedures and forms associated with that SFM application. Thus, business contacts that do not have a positive indication in the synchronization flag field will not be written to the queue for synchronization to the POM database when added, deleted, or modified.

Also, as shown in Table 1 above, embodiments of the present invention allow appointments as scheduled in the calendar of a POM application to be copied into the SFM database as a meeting activity record through the synchronization processes. In such embodiments, calendar appointment records can be created in the POM application interface in the typical manner using standard POM application processes and procedures. Since most SFM applications also allow sales team members or administrators to track contact points and other meeting activities with representatives of that particular account/contact, and since users very often use POM applications to keep track of appointments in a “calendar,” meetings and appointment information can be shared and synchronized between the POM component and the SFM component to facilitate sales force activity tracking. In particular, any appointment records made in the POM application that include business contacts as invitees are eligible for synchronization into the SFM database as a meeting activity. Preferably, only meetings created by that particular user (i.e., not those appointments created and forwarded by other users via their interface to their POM application and database) will be written to the queue and subsequently synchronized. Meetings that have more than one business contact as an invitee will be synchronized against all those business contacts.

In operation, after creating and/or modifying a calendar appointment record in the POM interface where that appointment record designates a synchronized business contact as an invitee, the user will be presented with a dialog box upon closing and updating the POM database record giving the option to synchronize the updated record with the SFM database. Optionally, the user at this time could be prompted to enter a meeting or activity summary description, comprising a few sentences describing the substance of the meeting or activity, which summary description will synchronized into the SFM database for archiving and future review by other users. If the user opts for the synchronization of the appointment to a meeting in the SFM database as a sales force activity, the meeting will be flagged for future synchronization of the records, which will be triggered after the meeting occurs. After the meeting occurs (the scheduled time for the meeting passes without that calendar item having been updated, modified or deleted via the POM application interface), the corresponding record will automatically be written to the queue upon the next synchronization event, and then subsequently populated into the appropriate meeting activity record in the SFM database associated with that sales account contact (business contact). This meeting and activity information will register against the appropriate business contact in the SFM database as well as the account associated with that contact (if the particular SFM application employed supports a distinction between the two).

Preferably, sales force activity information synchronized in the above manner cannot be deleted from the SFM database via the POM application interface once the scheduled time for that appointment has passed, and thus once it has been queued for synchronization by the POM application. With respect to meeting activity information created by synchronization of appointments from the calendar of the POM application, as indicated in Table 1 above, any actions (modifications, deletions) performed on these activity records via the SFM database will not be synchronized back into the POM database. The synchronization action for appointments and meetings, in other words, is one-way, one-time from the POM database into the SFM database. This synchronization aspect of the invention for sales force activity data is necessary to reflect the inherent differences in purpose between personal calendar appointments in a POM application and meetings or activity records kept in an SFM application. Appointments are intended to serve merely as reminders for the particular local user while meetings and activities retained in an SFM database are meant to track formally the business relationship and contact points between the business contact and the sales force on an organization-wide basis. Meeting or activity information synchronized from the POM application can of course be deleted or modified in the SFM database via the SFM application interface if desired or necessary. This approach is believed to be the best manner in which to prevent loss of meeting or activity information.

A third type of information synchronized between the two components are termed herein as opportunity tasks. SFM applications are typically adapted not only to track occurred or past touch points (activities or meetings) between sales staff and business contacts/accounts, but also to assign upcoming account opportunities and required action items associated with those account opportunities activities to particular sales force members and track completion of those assigned required action items. Opportunity tasks according to the present invention are synchronized records that address the need to have such upcoming account opportunities and action items synchronized with the particular assigned user's POM database records as tasks or “to-do” items. According to embodiments to the present invention, any opportunities or action items created in the SFM application will be synchronized to the assigned user's POM database as tasks. Tasks commonly are descriptions of a particular job to be done associated with a time frame for doing that job, and often tasks may optionally support a progress indicator regarding the status of the task (completed, not started, percentage completed, etc.). Thus, these synchronized records are referred to herein as opportunity tasks.

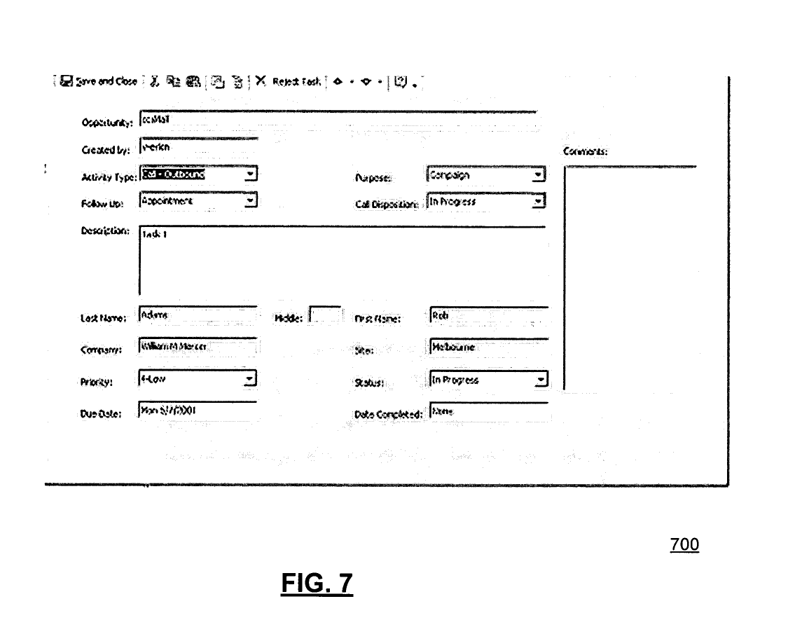

In embodiments to the present invention, it is anticipated that the standard task form as used by the POM application will have to be modified into another custom form to support all the fields required for an account opportunity or action item as created in the SFM application interface. FIG. 7 depicts a customized task form 700 accessible via the POM application's interface showing how a particular embodiment of opportunity tasks will be used in a preferred embodiment of the present invention. As shown in the figure, this form not only shows a date and time for the task to be performed by, but also designates a particular company and individual (corresponding to the account and/or business contact information) with which that opportunity task is associated. Once this particular opportunity task is assigned to the user, that user can update the progress of the task, modify due date, etc., and then have the updates reflected in the original record of the SFM database.

Any new tasks assigned to a particular user, once synchronized with that user's POM database, will appear in that user's POM application interface the when they review their tasks. That opportunity task will be designated as new and the user will have the opportunity, such as via a reject button, to review the opportunity task that has been synchronized over to them, and to reject or to accept it. If an opportunity task is rejected, the appropriate record will be deleted from their POM database, an appropriate record will be generated for synchronizing to the queue, and, after synchronizing, will cause the opportunity task to be reassigned to the user who created and assigned that opportunity task in the SFM application. Optionally, thereafter that rejected opportunity task record can be synchronized to the creating users POM database for review in their POM application. As with business contacts and appointments as described above, the creation, deletion and/or acceptance (progress updates) will be synchronized between the two components upon the next initiated synchronization.

A particular opportunity task may be resolved either through the POM or SFM application interfaces according to embodiments of the invention. Synchronization routines will ensure that the status of an opportunity task, open or closed (pending or completed), agrees in both databases. If the opportunity task is closed/completed by the assigned user via their POM application interface, the opportunity task will be deleted from the POM database and the corresponding record in the SFM database will be indicated as closed or completed after the next full synchronization. The reverse is also true for status changes made via the SFM interface.

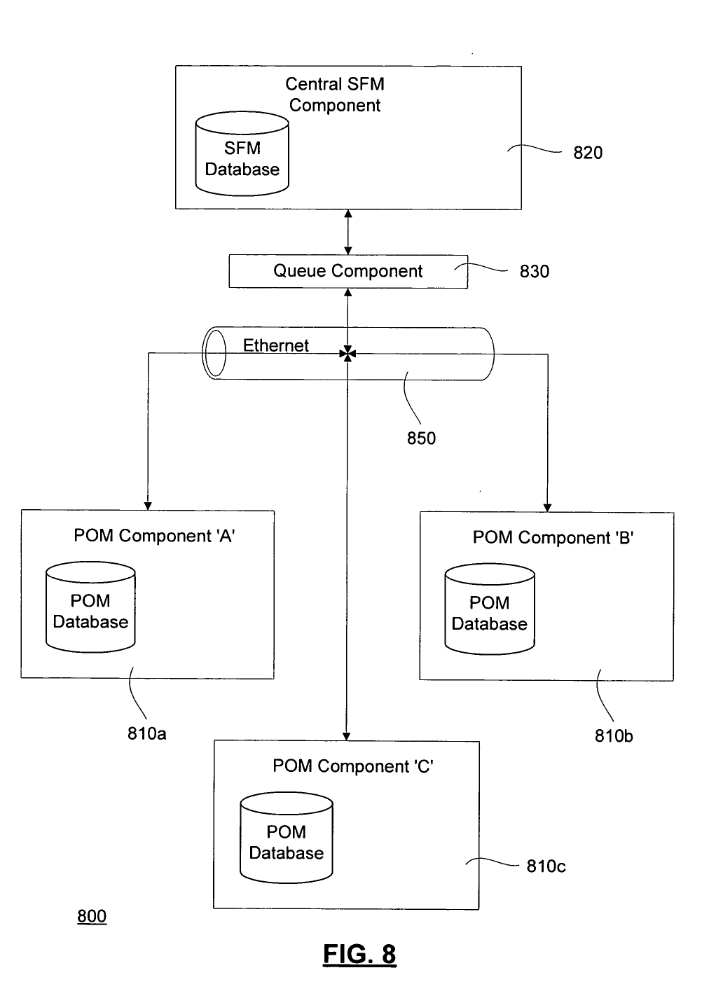

As described above, it is expected that the electronic tools according to preferred embodiments of the present invention will be used by many individual employees on a daily basis to organize personal contacts, appointment calendars, and tasks with sales force management applications used to manage client and account contact information and coordinate the pursuit of business opportunities on a organization-wide basis. With regard to such preferred embodiments, FIG. 8 depicts the association of various personal office management components 810a, 810b and 810c, corresponding to various users, with a centralized organization-wide sales force management component 820 through a single networked queue component via a distributed network, such as an ethernet connection 850, VPN, LAN or WAN.

Notably, especially in the case of a large distributed network with many sales force personnel, it may be desirable for the central SFM component 820 to have its database synchronized with the queue component 830 on a more regular basis than just at start-up of a SFM application. For example, the central SFM component could check the message queue for any updated messages written to the queue by the various POM components several times a day, such as hourly. If any updates are found, the SFM application will process those records and update its SFM database accordingly, similar in manner to how described above.

The foregoing description of the preferred embodiments of the invention has been presented for the purposes of illustration and description. It is not intended to be exhaustive or to limit the invention to the precise form disclosed. Many modifications and variations are possible in light of the above teaching. It is therefore intended that the scope of the invention be limited not by this detailed description, but rather by the claims appended hereto.

1. A system for synchronized electronically stored information relevant to personal office management functions and sales force management functions, said system comprising:
a personal office management (“POM”) component, said POM component comprising a POM database and a POM application that provides a front end user interface for managing POM data including personal contact data, appointment data and personal task data stored in said POM database;
a sales force management (“SFM”) component, said SFM component comprising a SFM database and a SFM application that provides a front end user interface for managing SFM data including account contact data, data regarding meetings and touch points with accounts or clients, and client or account opportunity action item data; and
a queue component, said POM component being in electronic communication with said SFM component via said queue component, and said queue component being adapted to operate as a temporary data storage area between said POM and SFM components for portions of said SFM data and said POM data that are designated as needing to be synchronized between said components; wherein
said data needing to be synchronized is of types selected from the group consisting of business contacts, sales force activities, and opportunity tasks.

2. The system according to claim 1, wherein said queue component comprises a synchronization engine that exchanges data needing to be synchronized back and forth between said SFM component and two or more of said POM components.

3. The system according to claim 2, wherein said synchronization engine sends and receives XML/XSLT data transmissions to synchronize said databases.

4. The system according to claim 1, wherein a synchronization event comprising exchange of said data needing to be synchronized to or from said queue component can occur in mechanisms selected from the group consisting of automatically, manually, on a transactional basis, and combinations thereof.

5. The system according to claim 1, wherein said POM component and said SFM component each synchronize automatically by reading portions of said data needing to be synchronized from said queue component whenever its related one of said POM application or said SFM application is opened, and by writing portions of said data needing to be synchronized to said queue component whenever its related one of said POM application or said SFM application is closed.

6. The system according to claim 1, wherein said synchronization of said POM component database can be driven from within the personal office management application in manners selected from the group consisting of automatic synchronization, manual synchronization and utility synchronization.

7. The system according to claim 1, wherein said POM application provides calendar contact management functionality and appointment management functionality wherein appointment reminders can be scheduled for contacts.

8. The system according to claim 7, wherein said POM application is a Microsoft Outlook application.

9. The system according to claim 8, wherein said SFM application provides business contact management functionality and execution management functionality wherein interaction of organization members with client contacts can be tracked.

10. The system according to claim 9, wherein said SFM application is Siebel Sales application.

11. The system according to claim 10, wherein said queue component comprises a Microsoft Queue application.

12. The system according to claim 9, wherein said queue component comprises queuing routines that adapted to handle queuing transactions with XML/XSLT data transmissions to exchange data between said POM database and said SFM database.

13. The system according to claim 7, wherein said SFM application provides business contact management functionality and execution management functionality wherein interaction of organization members with client contacts can be tracked.

14. The system according to claim 1, wherein said SFM application provides business contact management functionality and execution management functionality wherein interaction of organization members with client contacts can be tracked.

15. The system according to claim 14, wherein said SFM application is a Siebel Sales application.

16. The system according to claim 1, wherein said business contacts may be created via an interface of either application and then made accessible and modifiable via the other application's interface.

17. The system according to claim 16, wherein said business contacts may be first created or later accessed and edited via the personal office management application using free form fields, pick lists, multiple variable group lists or other data entry methods to limit bounded data fields required by the SFM application for account contacts.

18. The system according to claim 1, wherein said business contacts are adapted to support the different types and fields of information required by said personal contact data records of said POM application and said account contacts data records of said SFM application.

19. The system according to claim 18, wherein said POM component includes POM-queue integration module, said POM-queue integration module providing forms for use by said POM application for creation of business contact records to be synchronized.

20. The system according to claim 1, wherein said sales force activities comprise records created from appointment data in said POM component and relating to appointments scheduled in a user's calendar that have occurred and that involve interaction with at least one of said business contacts.

21. The system according to claim 1, wherein said sales force activities records are synchronized into said SFM database, and wherein said SFM database comprises an organization-wide database managed by the sales force management application that tracks interactions of sales force employees with business contacts of clients on an organization-wide basis.

22. The system according to claim 1, wherein said opportunity tasks comprise client or account opportunity action items that are assigned via said SFM application to users of said POM application as personal tasks.

23. The system according to claim 22, wherein a user can review any opportunity tasks assigned to him via said POM application and then review, accept or reject responsibility for said opportunity task.

24. The system according to claim 22, wherein a user can review record progress updates each opportunity tasks assigned to him using said POM application.

25. An electronic tool for synchronizing information contained within records created and utilized by an electronic personal office management (“POM”) application and an electronic sales force management (“SFM”) application, said POM component comprising a front end user interface that enables interaction with POM data stored in a POM database, said POM data including personal contact data, appointment data and personal task data, said SFM component comprising a front end user interface that enables interaction with SFM data stored in a SFM database, said SFM data including account contact data, data regarding meetings and touch points with accounts or clients, and client or account opportunity action item data, wherein said tool comprises:
a queue component, said POM database being in electronic synchronization with said SFM database via said queue component, and said queue component being adapted to operate as a temporary data storage area between said POM and SFM applications for portions of said SFM data and said POM data that are designated as needing to be synchronized between said applications;
a SFM-queue integration module adapted to be installed as a plug-in within said SFM application; and
a POM-queue integration module adapted to be installed as a plug-in
within said POM application; wherein said integration modules provide selectable functionalities in said applications for creating data records that for said data designated as needing to be synchronized and provide routines for synchronizing said data records via said queue component; said data records comprising types selected from the group consisting of business contacts, sales force activities, and opportunity tasks.

26. The tool according to claim 25, wherein said queue component comprises a synchronization engine that exchanges data needing to be synchronized back and forth between said SFM application and two or more of said POM applications, said two or more POM applications each corresponding to a different user.

27. The tool according to claim 26, wherein said synchronization engine sends and receives XML/XSLT data transmissions to synchronize said databases.

28. The tool according to claim 25, wherein a synchronization event comprising exchange of said data needing to be synchronized to or from said queue component can occur in mechanisms selected from the group consisting of automatically, manually, on a transactional basis, and combinations thereof.

29. The tool according to claim 24, wherein said routines of said POM-queue integration module and said routines of said SFM-queue integration module each synchronize automatically by reading portions of said data needing to be synchronized from said queue component whenever its related one of said POM application or said SFM application is opened, and by writing portions of said data needing to be synchronized to said queue component whenever its related one of said POM application or said SFM application is closed.

30. The tool according to claim 25, wherein said synchronization of said POM database can be driven from within the personal office management application in manners selected from the group consisting of automatic synchronization, manual synchronization and utility synchronization.

31. The tool according to claim 25, wherein said POM application provides calendar contact management functionality and appointment management functionality wherein appointment reminders can be scheduled for contacts.

32. The tool according to claim 31, wherein said POM application is a Microsoft Outlook application.

33. The tool according to claim 32, wherein said SFM application provides business contact management functionality and execution management functionality wherein interaction of organization members with client contacts can be tracked.

34. The tool according to claim 33, wherein said SFM application is Siebel Sales application.

35. The tool according to claim 34, wherein said queue component comprises a Microsoft Queue application.

36. The tool according to claim 33, wherein said queue component comprises queuing routines that adapted to handle queuing transactions with XML/XSLT data transmissions to exchange data between said POM database and said SFM database.

37. The tool according to claim 31, wherein said SFM application provides business contact management functionality and execution management functionality wherein interaction of organization members with client contacts can be tracked.

38. The tool according to claim 25, wherein said SFM application provides business contact management functionality and execution management functionality wherein interaction of organization members with client contacts can be tracked.

39. The tool according to claim 38, wherein said SFM application is a Siebel Sales application.

40. The tool according to claim 25, wherein said business contacts may be created via an interface of either application and then made accessible and modifiable via the other application's interface.

41. The tool according to claim 40, wherein said business contacts may be first created or later accessed and edited via the personal office management application using free form fields, pick lists, multiple variable group lists or other data entry methods to limit bounded data fields required by the SFM application for account contacts data records.

42. The tool according to claim 25, wherein said business contacts are adapted to support the different types and fields of information required by said personal contact data records of said POM application and said account contacts data records of said SFM application.

43. The tool according to claim 42, wherein said POM-queue integration module installs forms for use by said POM application for creation of business contact records to be synchronized.

44. The tool according to claim 25, wherein said sales force activities comprise records created from appointment data in said POM database and relating to appointments scheduled in a user's calendar that have occurred and that involve interaction with at least one of said business contacts.

45. The tool according to claim 25, wherein said sales force activities records are synchronized into said SFM database, and wherein said SFM database comprises an organization-wide database managed by the sales force management application that tracks interactions of sales force employees with business contacts of clients on an organization-wide basis.

46. The tool according to claim 25, wherein said opportunity tasks comprise client or account opportunity action items that are assigned via said SFM application to users of said POM application as personal tasks.

47. The tool according to claim 46, wherein a user can review any opportunity tasks assigned to him via said POM application and then review, accept or reject responsibility for said opportunity task.

48. The tool according to claim 46, wherein a user can review record progress updates each opportunity tasks assigned to him using said POM application.
